(19) United States
(12) Patent Application Publication
(10) Pub. No.: US 2005/0114588 A1
(43) Pub. Date: May 26, 2005

(54) Method and apparatus to improve memory performance

(76) Inventors: Jonathan C. Lucker, Portland, OR (US); Robert W. Faber, Hillsboro, OR (US); Mark S. Isenberger, Corrales, NM (US)

Correspondence Address: INTEL CORPORATION, P.O. BOX 5326, SANTA CLARA, CA, 95056-5326, US

(21) Appl. No.: 10/722,813

(22) Filed: Nov. 26, 2003

(51) Int. Cl. G06F 12/00

(52) U.S. Cl. 711/103

(57) ABSTRACT

Briefly, in accordance with an embodiment of the invention, an apparatus and method to improve memory performance is provided. The method may include performing a read cycle that includes a destructive read operation and a write back operation, wherein the destructive read operation includes reading information from a first memory cell of a memory and wherein the write back operation includes writing the information read from the first memory cell to a second memory cell of the memory.

### BACKGROUND

In some memories, it may take several milliseconds or microseconds to perform a read cycle, i.e., to read information from a location in memory. Reducing the time it takes to perform a read cycle may improve the memory performance as may be measured in terms of memory operations per second. In order to improve memory performance, system designers are continually searching for alternate ways to read memories.

Thus, there is a continuing need for alternate ways to read information from a memory.

### BRIEF DESCRIPTION OF THE DRAWINGS

The subject matter regarded as the invention is particularly pointed out and distinctly claimed in the concluding portion of the specification. The present invention, however, both as to organization and method of operation, together with objects, features, and advantages thereof, may best be understood by reference to the following detailed description when read with the accompanying drawings in which:

FIG. 1 is a diagram illustrating a portion of a ferroelectric memory cell;

FIG. 2 is a graph of the polarization versus voltage properties of a ferroelectric cell;

FIG. 3 is a block diagram of a ferroelectric memory device;

FIG. 4 is a flow diagram illustrating a method to read information stored in a destructive read memory in accordance with one embodiment of the present invention;

FIG. 5 is a flow diagram illustrating a method to write information to a memory in accordance with one embodiment of the present invention; and

FIG. 6 is a block diagram illustrating a portion of a computing system in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “include” and “comprise,” along with their derivatives, may be used, and are intended to be treated as synonyms for each other. In addition, in the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

In the following description and claims, the term “data” may be used to refer to both data and instructions. In addition, the term “information” may be used to refer to data and instructions.

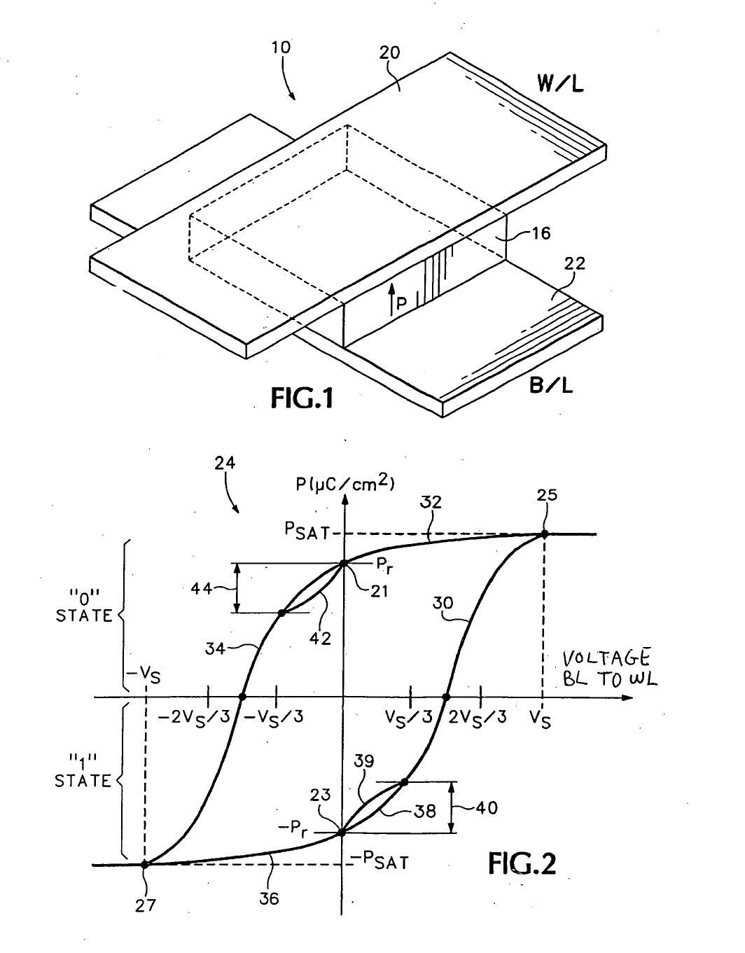

FIG. 1 is a diagram illustrating a portion of a ferroelectric memory cell 10 that may be used in embodiments of the present invention. Ferroelectric memory is a type of nonvolatile memory that utilizes the ferroelectric behavior of certain materials to retain data in a memory device in the form of positive and negative polarization, even in the absence of electric power. A ferroelectric material 16 may contain domains of similarly oriented electric dipoles that retain their orientation unless disturbed by some externally imposed electric force. The polarization of the material characterizes the extent to which these domains are aligned. The polarization can be reversed by the application of an electric field of sufficient strength and polarity.

Ferroelectric material 16 may be a ferroelectric polymer polarizable material, and may also be referred to as a ferroelectric polarizable material or a dipole ferroelectric material. In various embodiments, the ferroelectric polymer material may comprise a polyvinyl fluoride, a polyethylene fluoride, a polyvinyl chloride, a polyethylene chloride, a polyacrylonitrile, a polyamide, copolymers thereof, or combinations thereof. Another example of a ferroelectric material may include a ferroelectric oxide material.

A ferroelectric material 16 having a polarization P may be located between a conductive word line 20 and a conductive bit line 22. An electric field may be applied to the ferroelectric cell by applying an electric potential (voltage) between the word line (WL) and the bit line (BL) so as to effect changes in the polarization of the ferroelectric material.

FIG. 2 shows a simplified hysteresis curve 24 that illustrates idealistically the polarization versus voltage properties of the ferroelectric cell of FIG. 1. When a positive voltage (e.g., V_{bit line}−V_{word line}>0) of sufficiently large magnitude (shown here, for example, as Vs) is applied to the cell, all of the domains in the cell are forced to align, to the extent possible, in the positive direction, and the polarization P reaches the saturation polarization Psat at point 25 on the curve. A further increase in the voltage produces no further increase in the polarization because all of the domains are already aligned as far as possible in the direction of the electric field produced by the voltage between the word line and bit line. In one example, a positive voltage may be applied by applying Vs, e.g., about nine volts, to bit line 22 and applying about zero volts to word line 20. In other example, two non-zero positive voltages may be applied to bit line 22 and word line 20 to generate a positive voltage across material 16.

If the voltage is then reduced to zero (following path 32 to arrive at point 21), some of the domains switch their orientation (also referred to as rotating, flipping or reversing), but most of the domains retain their orientation. Thus, the ferroelectric material retains a remnant polarization Pr.

If a negative voltage of sufficiently large magnitude. (shown here, for example, as −Vs) is then applied to the word line 20 relative to bit line 22 (following path 34 to point 27), all of the domains are forced to switch their orientation, and the polarization reaches the negative saturation level −Psat. Removing this negative voltage (following path 36 to point 23) allows some of the domains to switch, and the cell polarization reaches the negative remnant polarization −Pr, which it retains until it is disturbed again. If the positive voltage Vs is again applied to the cell (following path 30 to point 25), the domains once again switch their orientation, and the cell takes on the positive saturation polarization Psat.

For purposes of data storage, ferroelectric cell 10 is considered to be in the logic “0” (zero) state when the polarization P is positive (preferably at Pr), and the logic “1” (one) state when the polarization is negative (preferably at −Pr). The assignment of a logic “1” or logic “0” to a positive or negative polarization is arbitrary, and in other embodiments, opposite conventions may be used.

A certain amount of charge may be required to switch the polarity of a domain, so the further the polarization moves along the P axis in FIG. 2, the more domains that are switched and the more charge is required. Thus, the transition from the logic 1 state at point 23 to the logic 0 state at point 25 is accompanied by a substantial release of charge, whereas the transition from point 21 to 25 (no change of state) is accompanied by very little charge release.

This difference in charge release provides the fundamental principle for a “destructive” read of a ferroelectric cell. In some memory storage technologies, an operation to read data from a memory location may cause the data to be destroyed. This is sometimes referred to as a destructive read operation and may result from the type of storage media used or how the memory system is designed. Some nonvolatile memories for example have destructive read operations. Destruction of the data in a particular memory location may include erasing, clearing, resetting, and/or overwriting the memory location. In such memory devices, the data read may be written back after being read in order to behave in a nondestructive read memory device manner.

In one example, to perform a destructive read, a negative voltage sufficient to switch the polarization is applied to cell 10 while the charge released from the cell is observed. A large charge release indicates that the cell was a logic zero, whereas little or no charge release indicates that the cell was a logic one. The cell ends up in the one state, regardless of its state before the read operation. Thus, a cell that was in the zero state must then be rewritten as a zero if further data retention is required.

Ferroelectric materials also exhibit resilience, wherein a ferroelectric cell can return to its remnant polarization despite a small disturbance. For example, assuming a one state storage condition for a ferroelectric cell, as represented by remnant polarization position 23 of hysteresis curve 24, a small voltage disturbance of Vs/3 may provide a small polarization shift 40 along path 38. However, once the voltage is removed, domains of the ferroelectric cell may realign their orientations to that of the cell's overall orientation, as illustrated by return path 39 of hysteresis curve 24.

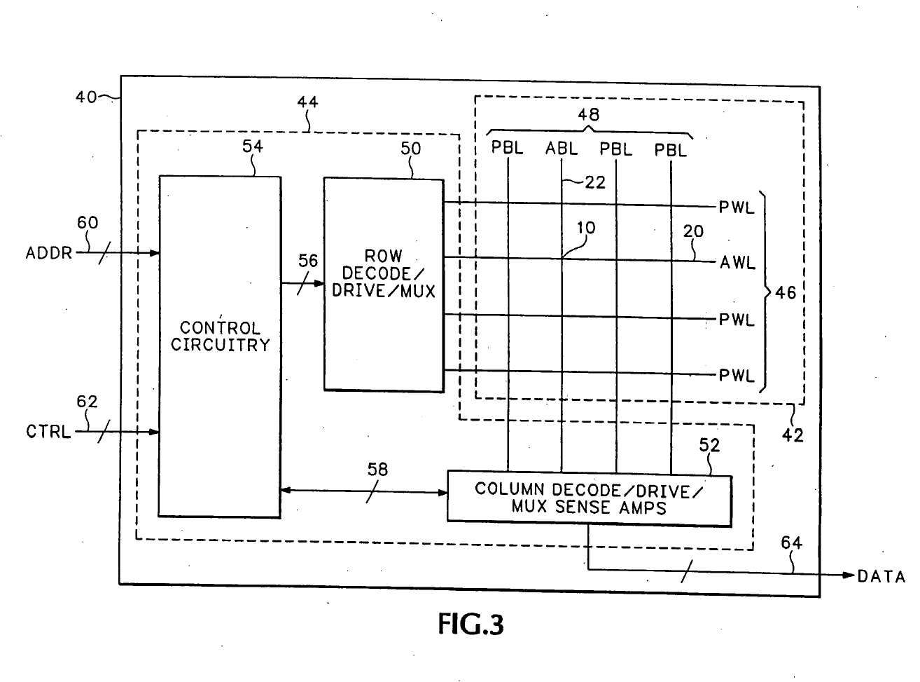

FIG. 3 is a block diagram illustrating a ferroelectric memory device 40 in accordance with an embodiment of the present invention. Memory device 40 includes a cross-point passive matrix memory array 42 having word lines 46 that cross bit lines 48. Ferroelectric material such as, for example, a ferroelectric polymer material, may be disposed between the word lines and bit lines to form ferroelectric cells at the intersections of word lines and bit lines. For example, a ferroelectric cell 10, such as that shown in FIG. 1, is located at the crossing of the word line identified as 20 and the bit line identified as 22 in FIG. 3. In this example, cell 10 is referred to as “active” because it identifies a specific cell that has been selected to read. The word line coupled to the active cell is identified as an active word line (AWL), whereas the remaining word lines are passive word lines (PWL). Likewise, the bit line coupled to the active cell is identified as the active bit line (ABL), whereas the remaining bit lines are passive bit lines (PBL). Passive word lines and bit lines may also referred to as unselected word lines and bit lines. Active word lines and bit lines may also be referred to as selected, addressed, or target word lines and bit lines.

When reading an active cell, a read or switching level voltage (−Vs) is applied to the active bit line 22. The read level voltage has a magnitude that is defined as (V_{bitline}−V_{wordline}), and is sufficient to effect a polarization reversal of the active cell 10. Thus, the active cell is destructively read, wherein application of the read level voltage may switch the cell's polarization state. To restore the stored data after a polarization reversal, the data may be written back into the active cell. In some embodiments, memory array 42 may be partitioned or segmented into subarrays, and during a read cycle data may be written back to another memory cell as described below.

During the read, the passive bit lines and passive word lines may be driven with voltages that provide quiescent level electric fields across the passive ferroelectric cells. Quiescent level voltages may be defined in accordance with the resilient qualities of the ferroelectric cell, wherein polarization disturbances of the cells are kept within a recovery range. For example, in accordance with one embodiment of the present invention, the quiescent level may be set to a magnitude no greater than ⅓ the switching level voltage.

Referring again to FIG. 3, the word lines 46 may be driven by a row decoder block 50 that selects which of the word lines to drive as an active word line and which to drive as passive word lines in response to various control and buffered address signals 56 from control circuitry 54. The bit lines 48 may be driven and sensed by a column decoder block 52 that selects which of the bit lines to drive and as an active bit line and which to drive as passive bit lines in response to various control and buffered address signals 58 from the control circuitry. The column decoder block 52 also includes one or more sense amplifiers to facilitate reading of the active ferroelectric cell to provide output data 64.

The control circuitry 54 may include some or all of various components such as, for example, address buffers, read sequencers, data samplers or the like for controlling the overall operation of the memory device 40 in response to address signals 60 and control signals 62 from outside the device.

The row decoder block 50 may include various components such as, for example, row decoders, word line drivers, multiplexers, low-to-high voltage converters, etc. as may be required for the particular architecture employed in the memory device. For example, if the memory array 42 is divided into subarrays, then a multiplexer may be used to switch the word line drive signals between the subarrays. The column decoder block 52 may include various combinations of column decoders, bit line drivers, mulitplexers, sense amplifiers, write drivers, etc.

Taken together, the control circuitry, row decoder block, and column decoder block may form the peripheral circuitry 44 that interfaces the memory array 42 to the external world. However, the system of FIG. 3 is only exemplary, and various arrangements of peripheral circuitry may be employed without departing from the principles of present invention.

As discussed above, a ferroelectric polymer memory may store information by polarizing electric dipoles in a polymer film in one of two directions. In one embodiment, the polarization may be “flipped” by applying a specified drive voltage, e.g., Vs, across the polymer memory material, which is a polarizable material. A positive Vs may flip the polarization in one direction, and a negative voltage may flip the polarization in the opposite direction. The drive voltage of −Vs that is sufficient for switching the polarization state of a memory cell may be referred to as a read voltage and Vs may be referred to as a write voltage, although the scope of the present invention is not limited in this respect.

To write information, a write cycle may include an erase operation followed possibly by a write operation depending on the desired logic state in the memory cell. The erase operation may polarize the material in one direction, i.e., place the material in a specified or desired logic state ( e.g., store a logic “1”). Then, at a later point in time, the logic state stored in the memory cells may either remain at a logic “1” or may be selectively changed to a store a logic “0” by performing a write operation that may apply a voltage across the memory cell that is opposite in polarity compared to the voltage applied during the erase operation.

Also discussed above, reads may be destructive. To read information from a destructive read memory, a read cycle may include a destructive read operation and a subsequent write back operation. Since information stored at a particular physical address of the memory may be lost during the destructive read operation, the information may be written back to the memory to restore it. The destructive read operation may polarize the material in one direction, i.e., place the material in a specified or desired logic state ( e.g., store a logic “1”). Then, at a later point in time, the logic state stored in the memory cells may either remain at a logic “1” or may be selectively changed to a store a logic “0” by performing a write back operation that may apply a voltage across the memory cell that is opposite in polarity compared to the voltage applied during the destructive read operation. Accordingly, the write operation of a write cycle may be similar to the write back operation of a read cycle.

In one example, if information read from a requested address is written back to the same address, neighboring unselected memory cells sharing the same word line or bit line as the selected memory cell may experience “disturbances” of Vs/3 when neighboring selected cells are written.

In a ferroelectric polymer memory, for a period of time immediately following a “flip” of polarization, the polymer memory cell may lose polarization if subjected to a disturb voltage. For example, this may happen when a read is followed by a write to the same cell, or when a write to one cell is followed by a write to a neighboring cell. As is illustrated below with reference to the methods of FIGS. 7 and 8, to avoid changes in polarization, delays or pauses may be used during reading and writing to a polymer memory. The delays may lengthen the time between flips and disturbances to avoid loss of data.

The amount of delay time used may depend on the electrode material (not shown) that is coupled to the polymer material of each memory cell. The interaction of the electrode material with the polymer memory material may result in a disturbance of the polarization in the memory cell if two memory operations are performed within a relatively short period of time.

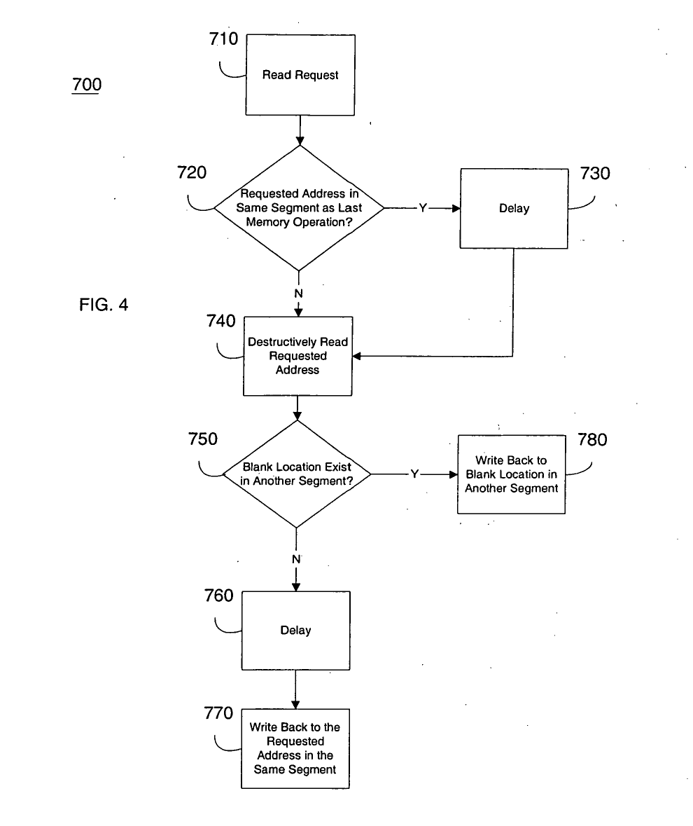

Turning to FIG. 4, shown is a flow diagram illustrating a method 700 to read information stored in a destructive read memory in accordance with one embodiment of the present invention. Method 700 may begin with receiving a request to read information from a requested address or location in a memory (block 710). For example, control circuitry 54 of FIG. 3 may receive a request to read information from a requested address in memory array 42.

In one embodiment, the total memory capacity of a memory may be separated into at least two separately addressable memory segments. These segments may also be referred to as arrays or regions, and may be physically separated from each other.

Referring back to FIG. 4, after receiving the read request, it may be determined whether the requested address is in the same memory segment as the last, or most recent, memory operation (diamond 720). A memory operation may be a read, a write, or an erase operation, although the scope of the present invention is not limited in this respect. An erase operation may be part of a read cycle or a write cycle.

If it is determined that the requested address is in the same memory segment as the last memory operation, then a delay operation may be performed (block 730). In one example, a timer or counter may be used to delay the reading of information from the requested address for a predetermined amount of time after the prior memory operation was performed. After the predetermined amount of time has passed, then information may be destructively read from the requested address (block 740). In one example, a delay of 100 microseconds may be used between memory operations in the same segment.

If the requested address is not in the same memory segment as the last memory operation, then the destructive reading of information from the requested address may be performed immediately without delay (block 740). For example, the reading of information from the requested address may be performed during the successive clock cycle after it is determined that the requested address is not in the same memory segment.

After the information is destructively read from the requested address, then it may be determined whether a blank location exists in another segment, i.e., a segment other than the segment where the requested address is located (diamond 750). If a blank location does not exist in another segment, then a delay operation may be performed (block 760). A blank location may refer to a location that has been previously erased either by an erase operation or a destructive read operation. Although the scope of the present invention is not limited in this respect, in one example, a delay of 100 microseconds [may be used between memory operations in the same segment. After the predetermined amount of time has passed, then information may be written back to the requested address in the same segment (block 770).

If a blank location exists in another segment, then the write back operation may include writing back the information read from the requested address to the blank location in the other segment (block 780). Writing information to another segment of memory rather than same segment, may improve memory performance by avoiding delay operations. “Sneak” current may refer to a residual current that may flow in a segment after a write and may interfere with a subsequent read. By writing information to another segment rather than the same segment during a write back operation, this may allow “sneak” current to settle. In addition, by moving information to a new location during a write back operation, information that is accessed frequently may be moved around the chip, thereby leveling or evening out the wear patterns of the memory. This may extend the life of the memory. In summary, method 700 may allow for faster operation, reducing sneak current, and leveling of wear patterns, which may improve the speed, reliability, and lifetime of a destructive read memory.

In one embodiment, the total memory capacity of a polymer memory may be arranged into thirty-two separately addressable segments. The segments may be activated one at a time so that during a write, only the unaddressed cells within the active segment experience Vs/3 disturbances. Cells in the other thirty-one segments, do not. Without such segmentation, a read may consist of a read+writeback with the same address being active for both. Thus, the cells of the active segment may be vulnerable to a “disturb.” By segmenting the memory, the read and write back operations may be spatially separate in address space, not in time (as with pauses). This may be accomplished by reading one address and writing back to a blank location in another segment. Data is not lost, but rather moved to another segment in the memory. Because the write back operation is to a segment different from the destructive read operation, the cells that were flipped during the read may not be disturbed by the write back. Thus, faster speed or memory access times may be achieved without memory “disturbs.”

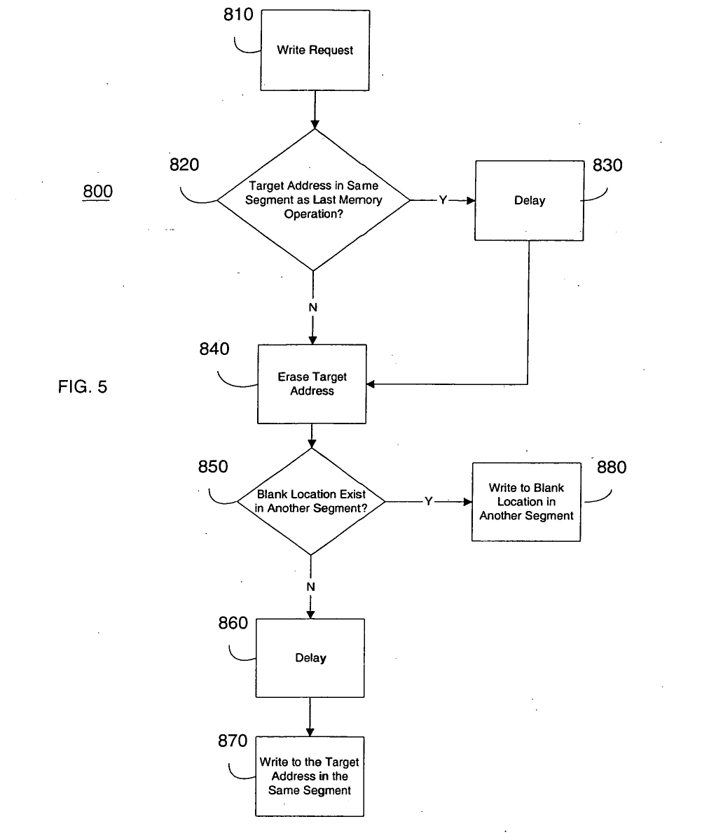

Turning to FIG. 5, shown is a flow diagram illustrating a method 800 to write information to a memory in accordance with one embodiment of the present invention. Method 800 may begin with receiving a request to write information to a target address or location in a memory (block 810). For example, control circuitry 54 of FIG. 3 may receive a request to write information to a target address in memory array 42.

In one embodiment, the total memory capacity of a memory may be separated into at least two separately addressable memory segments. In various embodiments, segmentation of a memory into at least two memory segments may be achieved by physically separating word lines and bit lines, using decode circuitry, and/or using one or more voltage sources.

After receiving the read request, it may be determined whether the target address is in the same memory segment as the last, or most recent, memory operation (diamond 820). If it is determined that the requested address is in the same memory segment as the last memory operation, then a delay operation may be performed (block 830). In one example, a timer or counter may be used to delay the writing of information from the requested address for a predetermined amount of time after, the prior memory operation was performed.

After the predetermined amount of time has passed, then the target address may be erased (block 840). In one example, a delay of 100 microseconds may be used between memory operations in the same segment. If the target address is not in the same memory segment as the last memory operation, then the erasing of the target address may be performed immediately without delay (block 840).

After erasing the target address, then it may be determined whether a blank location exists in another segment, i.e., a segment other than the segment where the targeted address is located (diamond 850). If a blank location does not exist in another segment, then a delay operation may be performed (block 860). After the delay operation, then information may be written to the target address in the same segment to satisfy the write request (block 870).

In some embodiments, both the erase and destructive read operations may polarize the material in one direction, i.e., place the material in a specified logic state (e.g., store a logic “1”). Then, at a later point in time, the memory cells may either remain at a logic “1” or may be selectively changed to a logic “0” by performing a write back operation or a write operation.

If a blank location exists in another segment, then information may be written to the blank location in the other segment to satisfy the write request (block 880). Writing information to another segment of memory rather than same segment after an erase operation, may improve memory performance by avoiding delay operations.

Generally, embodiments described above provide a method to reduce memory disturbs in unselected cells and improve memory performance by partitioning a memory into at least two memory segments, creating blanks in one segment either by, e.g., a destructive read operation or an erase operation, and then, performing a write or a write back operation in another memory segment. By increasing the number of segments, it will be less likely that a delay operation will need to be performed. For example, in a memory with thirty-two physically separated memory segments, there is less than a 4% (1 out of 32) chance that a delay operation may be used.

In one embodiment, a read from a requested address may include reading all memory cells in a row of an array. This may be accomplished by applying a read pulse to a single word line, and applying zero volts to all bit lines of the array. Similarly, memory cells may be written to by writing to the full width of the array, which may refer to writing to all memory cells in a row of an array. In one embodiment, the size of the array may be 512 bytes, although the scope of the present invention is not limited in this respect.

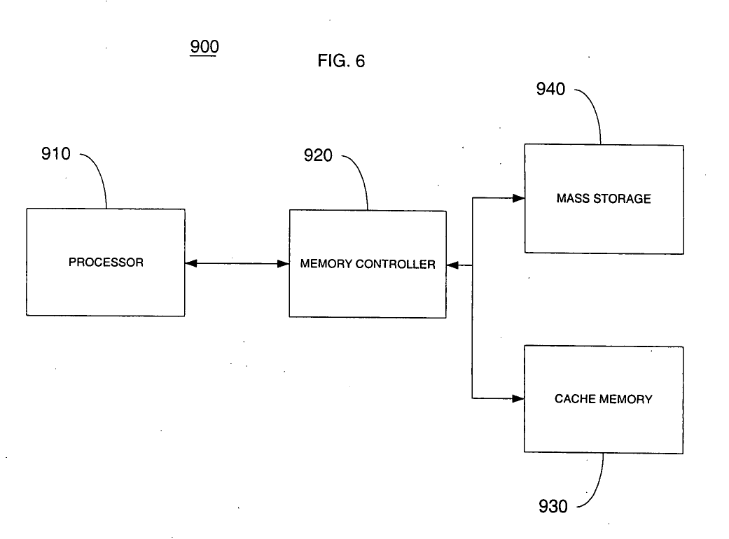

Turning to FIG. 6, shown is a block diagram of a computing system 900 in accordance with an embodiment of the present invention. As shown in FIG. 6, in one embodiment computing system 900 may include a processor 910, a memory controller 920, a cache memory 930, and a mass storage 940.

Processor 910 may be a general-purpose or special-purpose processor such as a microprocessor, microcontroller, application specific integrated circuit (ASIC), a programmable gate array (PGA), or the like.

In one embodiment, cache memory 930 include memory 40 as discussed above with reference to FIG. 3. In addition, in various embodiments, computing system 900 may be adapted to implement method 700 (FIG. 4) and/or method 800 (FIG. 5) discussed above.

In one embodiment, cache memory 930 may be a relatively large non-volatile disk cache memory adapted to cache information for mass storage 940. For example, cache memory 930 may be a ferroelectric polymer memory. To implement methods 700 or 800, cache memory 930 may be partitioned into at least two memory segments. Mass storage 940 may be a mass storage device such as, for example, a disk memory having a storage capacity of at least about one gigabyte. Mass storage 940 may be an electromechanical hard disk memory, an optical disk memory, or a magnetic disk memory, although the scope of the present invention is not limited in this respect. In one embodiment, cache memory 930 may have a storage capacity of at least about 500 megabytes and may include ferroelectric memory cells, wherein each cell includes a ferroelectric polymer material located between at least two conductive lines. The ferroelectric polymer material may be a ferroelectric polarizable material. In various embodiments, the ferroelectric polymer material may comprise a polyvinyl fluoride, a polyethylene fluoride, a polyvinyl chloride, a polyethylene chloride, a polyacrylonitrile, a polyamide, copolymers thereof, or combinations thereof.

In an alternate embodiment, cache memory 930 may be another type of plastic memory such as, for example, a resistive change polymer memory. In this embodiment, the plastic memory may include a thin film of polymer memory material sandwiched at the nodes of an address matrix. The resistance at any node may be altered from a few hundred ohms to several megohms by applying an electric potential across the polymer memory material to apply a positive or negative current through the polymer material to alter the resistance of the polymer material. Potentially different resistance levels may store several bits per cell and data density may be increased further by stacking layers.

Accordingly, as discussed above, methods, apparatuses, and systems have been provided to reduce memory disturbs and improve memory performance. In one embodiment, a method includes performing a read cycle in a memory, wherein the read cycle may include a destructive read operation and a write back operation. The memory may be a non-volatile ferroelectric polymer memory, although the scope of the present invention is not limited in this respect. The destructive read operation may include reading information from a first memory cell of the memory and the write back operation may include writing the information read from the first memory cell to a second memory cell of the memory if the second memory cell is available, e.g., erased or blank. The first memory cell may be located in a first segment of the memory and the second memory cell may be located in a second segment of the memory that is physically separated from the first segment. The method may further include writing the information read from the first memory cell back to the first memory cell if the second memory cell is not blank and after a predetermined amount of time has passed.

The method may further include delaying writing to, or reading from, the first memory cell for a predetermined amount of time if another memory operation to the first memory cell follows the destructive read operation. The other memory operation may be an erase operation that includes applying a voltage having a negative polarity and sufficient to switch the polarization of the first memory cell across the first memory cell to erase the memory cell to store a logic value of, e.g., a logic “1”. Alternatively, the other memory operation may be a write operation that includes applying a positive voltage across the first memory cell to program the memory cell to store a logic “0” value.

In another embodiment, a method includes receiving a request to write information to a first location in a ferroelectric polymer memory. This method may future include writing the information only to a second location, in the ferroelectric polymer memory and not writing the information to the first location in response to the request if the second location is available. The first location may be in a first array of the ferroelectric polymer memory and the second location may be in a second array of the ferroelectric polymer memory, wherein the first array is physically separated from the second array. The ferroelectric polymer memory may be a destructive read disk cache memory, although the scope of the present invention is not limited in this respect.

In another embodiment, an apparatus includes a memory having at least two memory arrays and a read circuit or memory controller coupled to the memory to perform a read cycle that includes a destructive read operation and a write back operation, wherein the destructive read operation includes reading information from a first memory cell of the memory and wherein the write back operation includes writing the information read from the first memory cell to a second memory cell of the memory. The read circuit may be a portion of peripheral circuitry 44 (FIG. 3) or memory controller 920 described above.

The memory of the apparatus may be a ferroelectric polymer memory, a ferroelectric oxide memory, or any other ferroelectric memory, although the scope of the present invention is not limited in this respect. In alternate embodiments, the memory may also be a non-ferroelectric memory. The memory may include at least two memory arrays, wherein each memory array may include ferroelectric memory cells that may include a layer of a ferroelectric polymer material having ferroelectric properties located between layers of electrodes.

While certain features of the invention have been illustrated and described herein, many modifications, substitutions, changes, and, equivalents will now occur to those skilled in the art. It is, therefore, to be understood that the appended claims are intended to cover all such modifications and changes as fall within the true spirit of the invention.

1. A method, comprising:
performing a read cycle that includes a destructive read operation and a write back operation; and
wherein the destructive read operation includes reading information from a first memory cell of a memory and wherein the write back operation includes writing the information read from the first memory cell to a second memory cell of the memory.

2. The method of claim 1, wherein reading information includes:
applying a read voltage across the first memory cell; and
determining the amount of charge released from the first memory cell to determine the logic state of the information stored in the first memory cell.

3. The method of claim 1, wherein writing the information includes applying a write voltage across the second memory cell.

4. The method of claim 1, further comprising: delaying writing to the first memory cell for a predetermined amount of time.

5. The method of claim 4, wherein the another memory operation includes applying a first voltage having a first polarity across the first memory cell, wherein the first voltage is sufficient to switch the polarization of the first memory cell.

6. The method of claim 1, wherein the destructive read operation includes reading information from a first memory cell of a non-volatile polymer ferroelectric disk cache memory.

7. The method of claim 1, wherein writing the information includes writing the information read from the first memory cell to a second memory cell if the second memory cell is blank.

8. The method of claim 7, wherein the write back operation further includes writing the information read from the first memory cell back to the first memory cell after a predetermined amount of time has passed.

9. The method of claim 1, wherein the first memory cell is located in a first segment of the memory and the second memory cell is located in a second segment of the memory that is physically separated from the first segment.

10. An article comprising a storage medium having stored thereon instructions, that, when executed by a computing platform, result in: performing a read cycle that includes a destructive read operation and a write back operation, wherein the destructive read operation includes reading information from a first memory cell of a memory and wherein the write back operation includes writing the information read from the first memory cell to a second memory cell of the memory.

11. The article of claim 10, wherein the instructions, when executed, further result in: delaying writing to the first memory cell for a predetermined amount of time.

12. The article of claim 10, wherein the destructive read operation includes reading information from a first memory cell of a non-volatile polymer ferroelectric disk cache memory and wherein writing the information includes writing the information read from the first memory cell to a second memory cell if the second memory cell is blank.

13. A method, comprising:
receiving a request to write information to a first location in a polymer memory; and
writing the information to a second location in the polymer memory in response to the request.

14. The method of claim 13, further comprising determining whether the second location is available and wherein the writing includes writing the information only to the second location in the polymer memory in response to the request.

15. The method of claim 13, wherein writing includes writing the information to the second location and not writing the information to the first location in response to the request if the second location is available.

16. The method of claim 13, wherein the first location is in a first array of the polymer memory and the second location is in a second array of the polymer memory, wherein the first array is physically separated from the second array.

17. The method of claim 13, wherein the polymer memory is a destructive read ferroelectric memory, and the first location is in a first segment of the polymer memory and the second location is in a second segment of the polymer memory, wherein the first segment is physically separated from the second segment.

18. An apparatus, comprising:
a memory having at least two memory arrays; and
a memory controller coupled to the memory to perform a read cycle that includes a destructive read operation and a write back operation, wherein the destructive read operation includes reading information from a first memory cell of the memory and wherein the write back operation includes writing the information read from the first memory cell to a second memory cell of the memory.

19. The apparatus of claim 18, wherein the first and second memory cells are ferroelectric memory cells comprising a non-volatile ferroelectric polymer material.

20. The apparatus of claim 19, wherein the non-volatile ferroelectric polymer material comprises a polyvinyl fluoride, a polyethylene fluoride, a polyvinyl chloride, a polyethylene chloride, a polyacrylonitrile, a polyamide, copolymers thereof, or combinations thereof.

21. A system, comprising:
a disk memory;
a disk cache memory coupled to the disk memory; and
a memory controller coupled to the memory to perform a read cycle that includes a destructive read operation and a write back operation, wherein the destructive read operation includes reading information from a first memory cell of the memory and wherein the write back operation includes writing the information read from the first memory cell to a second memory cell of the memory.

22. The system of claim 21, wherein the storage capacity of the disk cache memory is at least 500 megabytes and the storage capacity of the disk memory is at least one gigabyte.

23. The system of claim 21, wherein the disk cache memory is a non-volatile polymer memory.

24. The system of claim 21, wherein the disk cache memory is a non-volatile ferroelectric memory

25. The system of claim 21, wherein the first memory cell is located in a first array of the memory and the second memory cell is located in a second array of the memory that is physically separated from the first array.

26. A method, comprising:
receiving a request to write information to a first location in a ferroelectric memory; and
writing the information to a second location in the ferroelectric memory in response to the request.

27. The method of claim 26, further comprising determining whether the second location is available and wherein the writing includes writing the information only to the second location in the ferroelectric memory in response to the request.

28. The method of claim 26, wherein writing includes writing the information to the second location and not writing the information to the first location in response to the request if the second location is available, wherein the first location is in a first array of the ferroelectric memory and the second location is in a second array of the ferroelectric memory, and wherein the first array is physically separated from the second array.
